(19) United States
(12) Patent Application Publication
(10) Pub. No.: US 2023/0420182 A1
(43) Pub. Date: Dec. 28, 2023

(54) COIL-COMPONENT MANUFACTURING METHOD AND COIL COMPONENT

(71) Applicant: Murata Manufacturing Co., Ltd., Kyoto-fu (JP)

(72) Inventor: Akiumi OBA, Nagaokakyo-shi (JP)

(73) Assignee: Murata Manufacturing Co., Ltd., Kyoto-fu (JP)

(21) Appl. No.: 18/295,183

(22) Filed: Apr. 3, 2023

(30) Foreign Application Priority Data
Jun. 27, 2022 (JP) 2022-102898

(51) Int. Cl. H01F 41/00; H01F 27/29; H01F 27/28; H01F 1/147; H01F 41/04

(52) U.S. Cl. CPC H01F 41/005; H01F 27/292; H01F 27/2804; H01F 1/14766; H01F 41/04; H01F 2027/2809

(57) ABSTRACT

A coil-component manufacturing method includes producing an unfired multilayer body block including a stack of an unsintered magnetic layer and an unsintered coil conductor layer; applying pressure to the unfired multilayer body block; and by firing the unfired multilayer body block, producing a fired multilayer body block including a stack of a magnetic layer and a coil conductor layer. The method also includes impregnating the fired multilayer body block with resin; by scribing a surface of the fired multilayer body block impregnated with the resin, forming a break start point in the surface of the fired multilayer body block; by breaking the fired multilayer body block impregnated with the resin into individual chip units, producing a multilayer body; and by plating, forming an outer electrode on an outer surface of the multilayer body or on an outer surface of the fired multilayer body block.

### CROSS-REFERENCE TO RELATED APPLICATION

This application claims benefit of priority to Japanese Patent Application No. 2022-102898, filed Jun. 27, 2022, the entire content of which is incorporated herein by reference.

### BACKGROUND

### Technical Field

The present disclosure relates to a coil-component manufacturing method, and a coil component.

### Background Art

Japanese Unexamined Patent Application Publication No. 2020-141079 describes a passive component that is a surface mount component. The passive component includes a base body having insulating property, an internal conductor built in the base body, and outer electrodes that are disposed on the mounting face of the base body, and that are electrically connected with the internal conductor. The outer electrodes each include a face parallel to the mounting face of the base body, and a recess. The recess is recessed toward the mounting face of the base body relative to the parallel face, and has a circular or elliptical shape on the parallel face.

As described on paragraphs [0037] and [0038] of Japanese Unexamined Patent Application Publication No. 2020-141079, a coil component, which represents an embodiment of the passive component described in Japanese Unexamined Patent Application Publication No. 2020-141079, is produced by a process including cutting pressure-bonded green sheets into individual chip units by use of a dicer, force-cutting, or other methods, followed by firing at a predetermined temperature to form a base body, followed by forming outer electrodes on the bottom face of the base body. If, for example, the green sheets are made of a magnetic metal material, in cutting the green sheets along a cut face into individual chip units, the load exerted on the cut face causes breakage or elongation of metal magnetic powder at the cut face. This may cause an area with relatively high conductivity, in other words, an area with reduced surface resistance to occur in part of the surface of each individual chip unit. This may, duration formation of the outer electrodes, potentially lead to abnormal growth of plating, and to poor quality due to short-circuiting between the outer electrodes.

### SUMMARY

Accordingly, the present disclosure provides a coil-component manufacturing method that makes it possible to reduce a decrease in the surface resistance of the surface of a base body. Also, the present disclosure provides a coil component that makes it possible to reduce a decrease in the surface resistance of the surface of a base body.

A coil-component manufacturing method according to the present disclosure includes the steps of producing an unfired multilayer body block including a stack of an unsintered magnetic layer and an unsintered coil conductor layer, the unsintered magnetic layer including metal magnetic particles; applying pressure to the unfired multilayer body block; and by firing the unfired multilayer body block, producing a fired multilayer body block including a stack of a magnetic layer and a coil conductor layer, the magnetic layer including the metal magnetic particles. The coil-component manufacturing method also includes impregnating the fired multilayer body block with resin; by scribing a surface of the fired multilayer body block impregnated with the resin, forming a break start point in the surface of the fired multilayer body block; by breaking the fired multilayer body block impregnated with the resin into individual chip units, producing a multilayer body. The multilayer body includes a base body and at least one coil disposed in the base body. The breaking is performed by application of a pressing force to the break start point from a surface of the fired multilayer body block opposite from the surface in which the break start point has been formed, the base body including a stack of a plurality of the magnetic layers. The at least one coil includes a stack of a plurality of the coil conductor layers. The coil-component manufacturing method further includes by plating, forming an outer electrode on an outer surface of the multilayer body or on an outer surface of the fired multilayer body block, the outer electrode being electrically connected with the at least one coil.

A coil component according to a first aspect of the present disclosure includes a multilayer body including a base body, and at least one coil disposed in the base body, the base body including a stack of a plurality of magnetic layers, the at least one coil including a stack of a plurality of coil conductor layers; and an outer electrode that is disposed on an outer surface of the base body, and that is electrically connected with the at least one coil. The plurality of magnetic layers each include metal magnetic particles. The base body is impregnated with resin. The base body has a first major face and a second major face that are opposite to each other in a height direction; a first end face and a second end face that are opposite to each other in a length direction orthogonal to the height direction; and a first lateral face and a second lateral face that are opposite to each other in a width direction. The width direction is orthogonal to the height direction and to the length direction. At least one of the first end face, the second end face, the first lateral face, and the second lateral face has a surface roughness Sa greater than a surface roughness Sa of at least one of the first major face and the second major face.

A coil component according to a second aspect of the present disclosure includes a multilayer body including a base body, and at least one coil disposed in the base body. The base body includes a stack of a plurality of magnetic layers, and the at least one coil includes a stack of a plurality of coil conductor layers. The coil component also includes an outer electrode that is disposed on an outer surface of the base body, and that is electrically connected with the at least one coil. The plurality of magnetic layers each include metal magnetic particles. The base body is impregnated with resin. The base body has a first major face and a second major face that are opposite to each other in a height direction; a first end face and a second end face that are opposite to each other in a length direction orthogonal to the height direction; and a first lateral face and a second lateral face that are opposite to each other in a width direction. The width direction is orthogonal to the height direction and to the length direction. Area fractions of the resin exposed on a surface of at least one of the first end face, the second end face, the first lateral face, and the second lateral face have a mean value of greater than or equal to 30%, and a standard deviation of less than or equal to 6%.

The present disclosure makes it possible to provide a coil-component manufacturing method that makes it possible to reduce a decrease in the surface resistance of the surface of a base body. Further, the present disclosure makes it possible to provide a coil component that makes it possible to reduce a decrease in the surface resistance of the surface of a base body.

### BRIEF DESCRIPTION OF THE DRAWINGS

FIG. 1 is a flowchart of a first embodiment of a coil-component manufacturing method according to the present disclosure;

FIGS. 2A to 2L are exploded-view schematic illustrations of an exemplary method for producing an unfired multilayer body block;

FIG. 3 is a cross-sectional schematic illustration of an exemplary break-start-point forming step;

FIGS. 4A, 4B, and 4C are cross-sectional schematic illustrations of an exemplary breaking step;

FIG. 5A is a plan-view schematic illustration of an exemplary method for forming an insulating layer on a face where an underlying electrode is exposed;

FIG. 5B is a plan-view schematic illustration of an exemplary method for removing an insulating layer disposed on an underlying electrode;

FIG. 6 is a plan-view schematic illustration of an exemplary method for forming an outer electrode on an underlying electrode;

FIG. 7 is a flowchart of a second embodiment of the coil-component manufacturing method according to the present disclosure;

FIG. 8 is a schematic perspective view of an exemplary coil component according to the present disclosure;

FIG. 9 is a schematic illustration of the coil component illustrated in FIG. 8, depicting the interior of the coil component in a see-through manner for easy understanding of the structure of the coil;

FIG. 10 is a cross-sectional view, taken along a line X-X, of the coil component illustrated in FIG. 8;

FIG. 11 is a cross-sectional view, taken along a line XI-XI, of the coil component illustrated in FIG. 8;

FIG. 12 is a perspective-view schematic illustration of a first modification of the internal structure of the coil component according to the present disclosure;

FIG. 13 is a perspective-view schematic illustration of a second modification of the internal structure of the coil component according to the present disclosure;

FIG. 14 is a perspective-view schematic illustration of a third modification of the internal structure of the coil component according to the present disclosure; and

FIG. 15 is a plan-view schematic illustration of a method for measuring direct-current insulation resistance.

### DETAILED DESCRIPTION

A coil component and a coil-component manufacturing method according to the present disclosure will be described below. The present disclosure, however, is not limited to embodiments described below but may be practiced with various modifications and alterations without departing from the scope of the present disclosure. The present disclosure also extends to combinations of two or more preferred features individually disclosed herein.

Coil-Component Manufacturing Method

A coil-component manufacturing method according to the present disclosure includes the step of producing an unfired multilayer body block; the step of applying pressure to the unfired multilayer body block (to be referred to also as “pressure application step” hereinafter); the step of firing the unfired multilayer body block (to be referred to also as “firing step” hereinafter); the step of impregnating the fired multilayer body block with resin (to be referred to also as “resin-material impregnation step” hereinafter); the step of forming a break start point in a surface of the fired multilayer body block impregnated with the resin (to be referred to also as “break-start-point forming step” hereinafter); the step of breaking the fired multilayer body block (to be referred to also as “breaking step” hereinafter); and the step of forming an outer electrode on an outer surface of a multilayer body or on an outer surface of the fired multilayer body block (to be referred to also as “outer-electrode forming step” hereinafter).

### First Embodiment

Individual steps of a first embodiment of a coil-component manufacturing method according to the present disclosure will be described below with reference to the drawings.

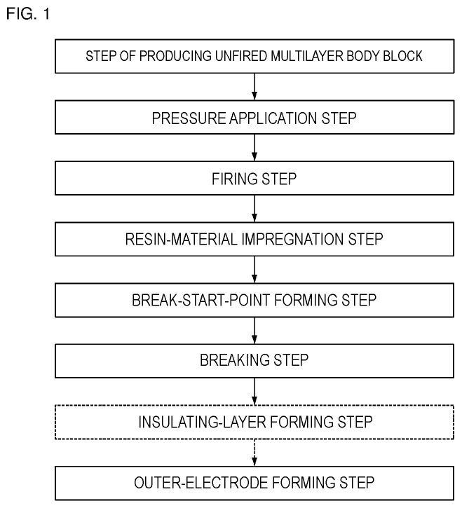

FIG. 1 is a flowchart illustrating a first embodiment of a coil component manufacturing method according to the present disclosure.

With the first embodiment of the coil-component manufacturing method according to the present disclosure, the step of producing an unfired multilayer body block, the pressure application step, the firing step, the resin-material impregnation step, the break-start-point forming step, the breaking step, the insulating-layer forming step, and the outer-electrode forming step are performed in the stated order.

Step of Producing Unfired Multilayer Body Block

The step of producing an unfired multilayer body block involves producing an unfired multilayer body block including a stack of an unsintered magnetic layer and an unsintered coil conductor layer, the unsintered magnetic layer including metal magnetic particles.

For example, the following materials are prepared: a magnetic paste including metal magnetic particles; a non-magnetic ferrite paste; and an internal-conductor paste used for forming an internal conductor.

The magnetic paste including metal magnetic particles may be produced by, for example, a method described below.

A metal magnetic powder of a Fe—Si alloy or Fe—Si—Cr alloy with a 50% cumulative particle size in terms of volume, D50, of greater than or equal to 2 μm and less than or equal to 20 μm (i.e., from 2 μm to 20 μm) is prepared. A binder such as cellulose or polyvinyl butyral (PVB), and a solvent such as a mixture of terpineol and butyl carbitol acetate (BCA) are added to the metal magnetic powder. The resulting metal magnetic powder is kneaded to thereby produce a magnetic paste.

If a Fe—Si alloy is to be used for the metal magnetic powder, it is preferable that the content of Si be greater than or equal to 2.0 at % and less than or equal to 8.0 at % (i.e., from 2.0 at % to 8.0 at %). If a Fe—Si—Cr alloy is to be used for the metal magnetic powder, it is preferable that the content of Si be greater than or equal to 2.0 at % and less than or equal to 8.0 at % (i.e., from 2.0 at % to 8.0 at %). If a Fe—Si—Cr alloy is to be used for the metal magnetic powder, it is preferable that the content of Cr be greater than or equal to 0.2 at % and less than or equal to 6.0 at % (i.e., from 0.2 at % to 6.0 at %).

The surface of the metal magnetic powder may be provided with an insulation coating. The insulation coating is preferably a coating containing a metal oxide, more preferably an oxide of Si. A preferred method for forming the insulation coating is the sol-gel method. Reference is now made to how an insulation coating is formed by the sol-gel method. A sol-gel coating agent containing Si alkoxide, and an organic chain-containing silane coupling agent are mixed together to form a liquid mixture. The liquid mixture is deposited onto the surface of the metal magnetic powder, and then subjected to heat treatment for dehydration synthesis. The resulting liquid mixture is then dried at a predetermined temperature to thereby form an insulation coating.

The non-magnetic ferrite paste may be produced by, for example, a method described below.

Fe₂O₃, NiO, ZnO, CuO, and other optional additives are weighed so as to obtain a predetermined composition. The weighed materials are placed in a ball mill together with pure water, a dispersant, and PSZ media, and mixed and pulverized to obtain a slurry. The obtained slurry is then dried and calcined at a temperature of greater than or equal to 700° C. and less than or equal to 800° C. (i.e., from 700° C. to 800° C.) for a duration of greater than or equal to two hours and less than or equal to three hours (i.e., from two hours to three hours) to thereby obtain a non-magnetic ferrite material (calcined powder). A solvent (such as a ketone-based solvent), resin (such as polyvinyl acetal), and a plasticizer (such as an alkyd-based plasticizer) are added in predetermined amounts to the non-magnetic ferrite material (calcined powder), which is then kneaded with a planetary mixer and further dispersed with a 3-roll mill to thereby produce a non-magnetic ferrite paste.

Preferably, the non-magnetic ferrite paste contains, as its main components, Fe in an amount of greater than or equal to 40 mol % and less than or equal to 49.5 mol % (i.e., from 40 mol % to 49.5 mol %) in terms of Fe₂O₃, and Cu in an amount of greater than or equal to 4 mol % and less than or equal to 12 mol % (i.e., from 4 mol % to 12 mol %) in terms of CuO, the remainder being ZnO. More preferably, the non-magnetic ferrite paste contains Mn, Bi, Co, Si, Sn, or other additives optionally added to the main components mentioned above. The non-magnetic ferrite paste may contain incidental impurities.

As the internal-conductor paste, for example, a paste containing silver as a conductive material is prepared.

Reference is now made to an exemplary method for producing an unfired multilayer body block by use of the materials mentioned above.

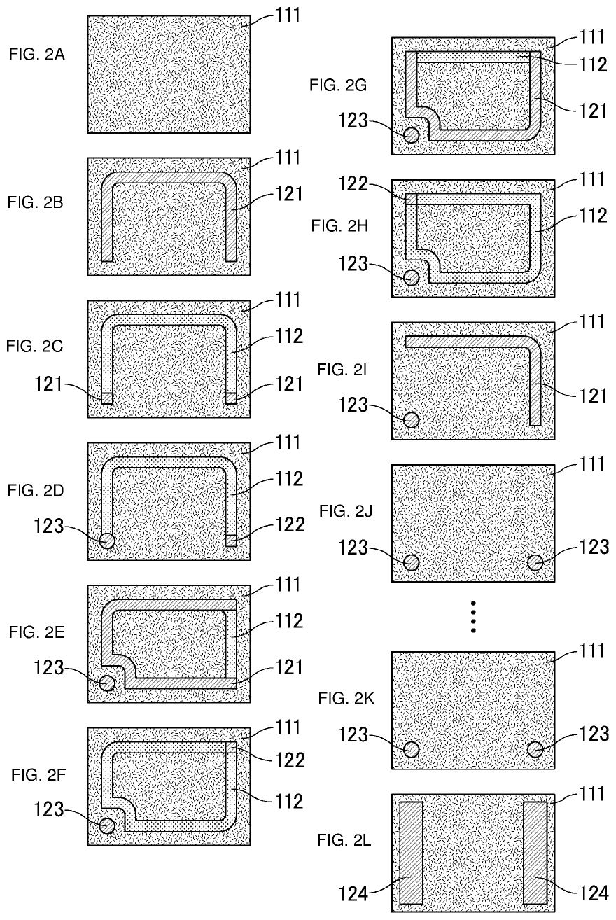

FIGS. 2A to 2L are exploded-view schematic illustrations of an exemplary method for producing an unfired multilayer body block. It is to be noted that FIGS. 2A to 2L illustrate coil patterns individually on a chip-by-chip basis, rather than the unfired multilayer body block as a whole.

A substrate including a thermal release sheet and a polyethylene terephthalate (PET) film that are stacked over a metal plate is prepared. This substrate is not illustrated in the drawings. A magnetic paste is applied onto the substrate a predetermined number of times by screen printing to thereby form a magnetic-paste printed layer 111, which is a layer printed with the magnetic paste (FIG. 2A). The magnetic-paste printed layer 111 is an unsintered magnetic layer, which is to become a magnetic layer after undergoing firing. The layer illustrated in FIG. 2A is to become an outer layer of the coil component after undergoing firing.

An internal-conductor-paste printed layer 121, which is a layer printed with a paste used for forming an internal conductor and which is to become a coil conductor layer, is formed on the magnetic-paste printed layer 111 illustrated in FIG. 2A. The internal-conductor-paste printed layer 121, which is to become a coil conductor layer, is an unsintered coil conductor layer that is to become a coil conductor layer after undergoing firing. Further, a magnetic-paste printed layer 111 is formed in a region where no internal-conductor-paste printed layer 121, which is to become a coil conductor layer, has been formed (FIG. 2B).

A non-magnetic-ferrite-paste printed layer 112, which is a layer printed with a non-magnetic ferrite paste, is formed in a region on the internal-conductor-paste printed layer 121 illustrated in FIG. 2B excluding the following regions: a region that connects with the coil conductor layer to be printed in the next layer; and a region that connects with an extended conductor. The non-magnetic-ferrite-paste printed layer 112 is an unsintered non-magnetic layer that is to become a non-magnetic layer after undergoing firing. A magnetic-paste printed layer 111 is then formed in a region excluding the following regions: a region where the non-magnetic-ferrite-paste printed layer 112 has been formed; a region that connects with the coil conductor layer to be printed in the next layer; and a region that connects with an extended conductor (FIG. 2C).

Subsequently, an internal-conductor-paste printed layer 122, and an internal-conductor-paste printed layer 123 are formed (FIG. 2D). The internal-conductor-paste printed layer 122 is to become a via-conductor (a conductor to be connected with the next coil conductor layer to be printed). The internal-conductor-paste printed layer 123 is to become an extended conductor.

An internal-conductor-paste printed layer 121, which is to become a coil conductor layer, and an internal-conductor-paste printed layer 123, which is to become an extended conductor, are formed. Further, a magnetic-paste printed layer 111 is formed in a region where no internal-conductor-paste printed layer (no printed layer that is to become a coil conductor layer or an extended conductor) has been formed (FIG. 2E).

A non-magnetic-ferrite-paste printed layer 112 is formed in a region on the internal-conductor-paste printed layer 121 excluding a region that connects with the next coil conductor layer to be printed. Subsequently, an internal-conductor-paste printed layer 122, which is to become a via-conductor, is formed, and an internal-conductor-paste printed layer 123, which is to become an extended conductor, are each formed in the region that connects with the next coil conductor layer to be printed. Further, a magnetic-paste printed layer 111 is formed in a region excluding the above-mentioned regions (FIG. 2F).

An internal-conductor-paste printed layer 121, which is to become a coil conductor layer, and an internal-conductor-paste printed layer 123, which is to become an extended conductor, are formed. Further, a magnetic-paste printed layer 111 is formed in a region where no internal-conductor-paste printed layer (no printed layer that is to become a coil conductor layer or an extended conductor) has been formed (FIG. 2G).

A non-magnetic-ferrite-paste printed layer 112 is formed in a region on the internal-conductor-paste printed layer 121 excluding a region that connects with the next coil conductor layer to be printed. Subsequently, an internal-conductor-paste printed layer 122, which is to become a via-conductor, and an internal-conductor-paste printed layer 123, which is to become an extended conductor, are each formed in the region that connects with the next coil conductor layer to be printed. Further, a magnetic-paste printed layer 111 is formed in a region excluding the above-mentioned regions (FIG. 2H).

Repeating the steps illustrated in FIGS. 2G to 2H a predetermined number of times makes it possible to adjust the number of coil turns in a suitable manner.

An internal-conductor-paste printed layer 121, which is to become a coil conductor layer, and an internal-conductor-paste printed layer 123, which is to become an extended conductor, are formed. Further, a magnetic-paste printed layer 111 is formed in a region where no internal-conductor-paste printed layer (no printed layer that is to become a coil conductor layer or an extended conductor) has been formed (FIG. 2I).

An internal-conductor-paste printed layer 123, which is to become an extended conductor, is formed, and a magnetic-paste printed layer 111 is formed in a region excluding where the internal-conductor-paste printed layer 123 has been formed. This process is repeated a predetermined number of times (FIGS. 2J to 2K).

An internal-conductor-paste printed layer 124, which is to become an underlying electrode for an outer electrode, is formed in a region that is to become the underlying electrode. Further, a magnetic-paste printed layer 111 is formed in a region where no internal-conductor-paste printed layer 124 has been formed (FIG. 2L).

Lastly, the stack of the printed layers described above is released from the metal plate, and the polyethylene terephthalate (PET) film is removed to thereby produce an unfired multilayer body block. As mentioned above, FIGS. 2A to 2L illustrate coil patterns individually on a chip-by-chip basis, which means that in actuality, a number of coil patterns corresponding to the number of chips included in the multilayer body block have been formed.

Pressure Application Step

In the pressure application step, pressure is applied to the unfired multilayer body block.

The unfired multilayer body block produced through the above-mentioned procedure is subjected to a pressure-application process in which the unfired multilayer body block undergoes warm isostatic pressing (WIP) or other pressing process.

Firing Step

In the firing step, the unfired multilayer body block is fired to thereby produce a fired multilayer body block. In the fired multilayer body block, magnetic layers including metal magnetic particles, and coil conductor layers are stacked.

For example, the unfired multilayer body block that has undergone the pressure application process is placed in a firing furnace, and then subjected to a de-binding process before being fired in the atmosphere. The firing is performed at a temperature of, for example, greater than or equal to 600° C. and less than or equal to 800° C. (i.e., from 600° C. to 800° C.). The firing is performed for a duration of, for example, greater than or equal to 30 minutes and less than or equal to 90 minutes (i.e., from 30 minutes to 90 minutes).

Resin-Material Impregnation Step

In the resin-material impregnation step, the fired multilayer body block is impregnated with resin.

For example, after the fired multilayer body block is impregnated with resin, heat is applied to the resulting fired multilayer body block to solidify the resin.

As the fired multilayer body block is impregnated with resin, voids between the metal magnetic particles of the multilayer body block are filled with the resin. This helps to ensure the strength of the base body for the coil component. This also helps to reduce entry of a plating solution, moisture, or other matter into the base body.

Break-Start-Point Forming Step

In the break-start-point forming step, the fired multilayer body block impregnated with resin is scribed to thereby form a break start point in a surface of the fired multilayer body block.

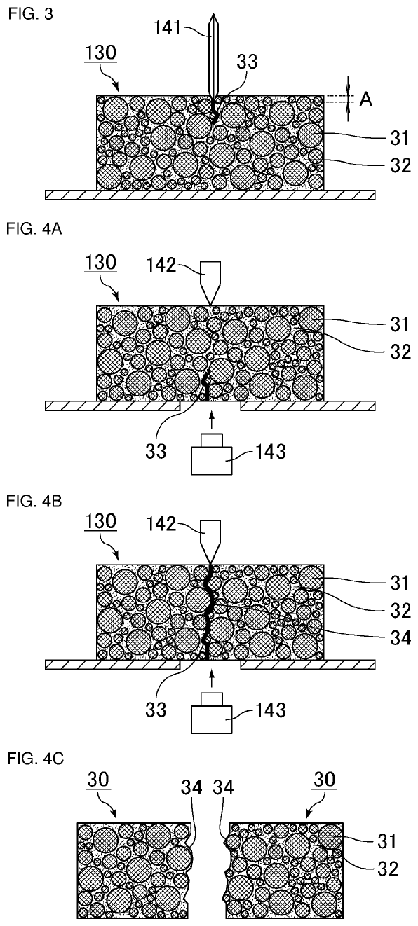

FIG. 3 is a cross-sectional schematic illustration of an exemplary break-start-point forming step.

As illustrated in FIG. 3, as seen in the cross-section of a multilayer body block 130 that has been fired and impregnated with resin, voids between metal magnetic particles 31 are impregnated with resin 32.

A surface of the multilayer body block 130 that has been fired and impregnated with the resin 32 is scribed to thereby form a break start point 33 in the surface of the multilayer body block 130 that has been fired. For example, as illustrated in FIG. 3, the break start point 33 can be formed by pressing a scribe wheel 141 into a surface of the multilayer body block 130, and running the scribe wheel 141. In FIG. 3, the scribe wheel 141 is moved in a direction toward and away from the plane of FIG. 3.

The scribe wheel 141 may be pressed into the surface of the multilayer body block 130 to a depth (a length represented by two arrows A in FIG. 3) of, for example, greater than or equal to 1 μm and less than or equal to 9 μm (i.e., from 1 μm to 9 μm), or to a depth of greater than or equal to 2 μm and less than or equal to 8 μm (i.e., from 2 μm to 8 μm).

After the break-start-point forming step, the depth of the break start point 33 may be, for example, greater than or equal to 1 μm and less than or equal to 9 μm (i.e., from 1 μm to 9 μm), or may be greater than or equal to 2 μm and less than or equal to 8 μm (i.e., from 2 μm to 8 μm).

Breaking Step

In the breaking step, the fired multilayer body block impregnated with resin is broken into individual chip units to thereby produce a multilayer body including a base body and a coil disposed in the base body. The breaking is performed by application of a pressing force to the break start point from a surface of the fired multilayer body block opposite from the surface in which the break start point has been formed. The base body includes a plurality of stacked magnetic layers, and the coil includes a plurality of stacked coil conductor layers.

FIGS. 4A, 4B, and 4C are cross-sectional schematic illustrations of an exemplary breaking step.

First, as illustrated in FIG. 4A, the multilayer body block 130 provided with the break start point 33 is turned upside down. In FIG. 4A, the multilayer body block 130 illustrated in FIG. 3 has been turned upside down so that the break start point 33 is now located at the bottom.

Subsequently, a break blade 142 is pressed into a surface (the upper surface in FIG. 4A) of the multilayer body block 130 opposite from the surface in which the break start point 33 has been formed. A pressing force is thus applied to the break start point 33. This causes a fracture face 34 to propagate starting at the break start point 33 as illustrated in FIG. 4B. The multilayer body block 130 is thus broken into individual chip units.

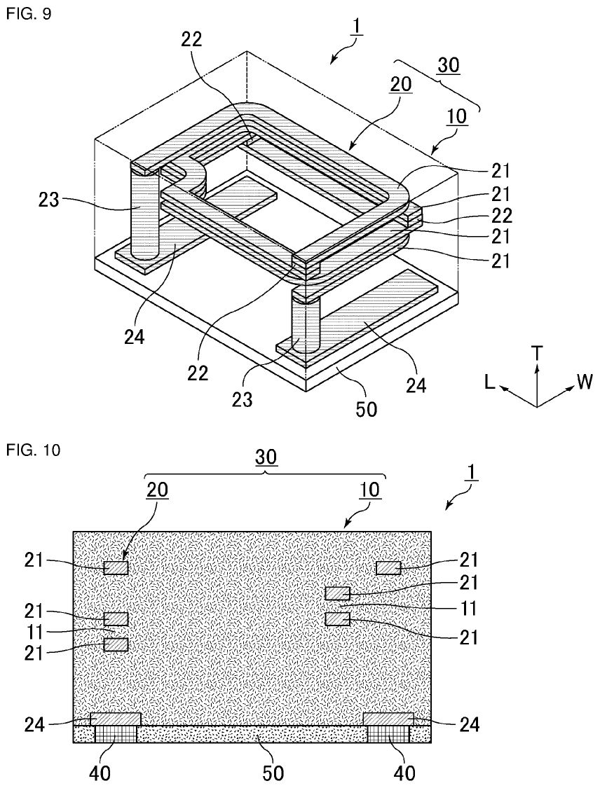

As a result, a multilayer body 30 (see FIG. 9 to which reference will be made later) can be produced as illustrated in FIG. 4C.

In the breaking step, the application of the pressing force causes the fracture face 34 to propagate starting at the break start point 33 as illustrated in FIG. 4B. The multilayer body block 130 has a low strength at the interface between each metal magnetic particle 31 and the resin 32 within the multilayer body block 130. Consequently, the fracture face 34 tends to propagate along the interface between each metal magnetic particle 31 and the resin 32 as illustrated in FIG. 4B. This helps to prevent breakage or elongation of the metal magnetic particles 31 at the fracture face 34, in comparison to a case where, for example, the multilayer body block 130 is cut by use of a dicer, force-cutting, or other methods. As a result, the amount of the metal magnetic particles 31 exposed on the fracture face 34 decreases, whereas the amount of the resin 32 exposed on the fracture face 34 increases instead. Further, at the fracture face 34, the presence of the resin 32 around the metal magnetic particles 31 causes the metal magnetic particles 31 to be insulated from each other. Since the fracture face 34 propagates along the interface between each metal magnetic particle 31 and the resin 32 as illustrated in FIG. 4B, the fracture face 34 is allowed to have an increased surface roughness. The above-mentioned arrangements make it possible to reduce a decrease in the surface resistance of the surface of the base body.

A potential problem that may arise if the fracture face has a low surface resistance is that, in forming an outer electrode on a face other than the fracture face in the subsequent steps, plating may abnormally grow to reach the fracture face. By contrast, reducing a decrease in the surface resistance of the fracture face, as with the coil-component manufacturing method according to the present disclosure, makes it possible to prevent abnormal growth of plating in forming an outer electrode.

A low surface resistance of the fracture face may also result in poor quality due to short-circuiting between outer electrodes. By contrast, reducing a decrease in the surface resistance of the fracture face, as with the coil-component manufacturing method according to the present disclosure, makes it possible to prevent poor quality resulting from short-circuiting between outer electrodes.

In the breaking step, as illustrated in FIGS. 4A and 4B, a pressing force may be applied to the break start point 33 while the break start point 33 is observed with a camera 143. In FIGS. 4A and 4B, the break blade 142 is pressed into the multilayer body block 130 with the break start point 33 being observed with the camera 143 from a side (the lower side in FIGS. 4A and 4B) of the multilayer body block 130 where the break start point 33 exists. As described above, the camera 143 is used to observe the break start point 33, and adjust where to apply the pressing force. This allows for high accuracy positioning of the multilayer body block 130 in the breaking step.

For example, in producing the multilayer body 30, which will be described later with reference to FIG. 9, at least one of a first end face 10c, a second end face 10d, a first lateral face 10e, and a second lateral face 10f of a base body 10 may be formed as the fracture face 34 obtained through the break-start-point forming step and the breaking step. Alternatively, all of the first end face 10c, the second end face 10d, the first lateral face 10e, and the second lateral face 10f of the base body 10 may be formed as such fracture faces 34.

Insulating-Layer Forming Step

The first embodiment of the coil-component manufacturing method according to the present disclosure may further include, between the step of breaking the fired multilayer body block and the step of forming the outer electrode, the step of forming an insulating layer in a region on an outer surface of the multilayer body. In this case, the outer electrode described later is preferably formed in a region surrounded by the insulating layer.

In the insulating-layer forming step, an insulating layer is formed in a region on an outer surface of the multilayer body.

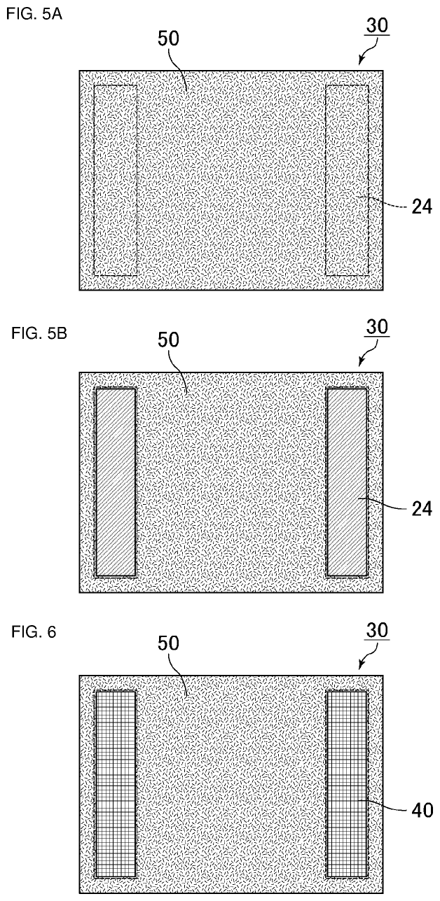

FIG. 5A is a plan-view schematic illustration of an exemplary method for forming an insulating layer on a face where an underlying electrode is exposed. FIG. 5B is a plan-view schematic illustration of an exemplary method for removing an insulating layer disposed on an underlying electrode.

Photosensitive resist resin is applied by screen printing onto the entirety of a face of the multilayer body 30 where an underlying electrode 24 is exposed. The resist resin is then dried. In this way, an insulating layer 50 is formed on the entirety of the face of the multilayer body 30 where the underlying electrode 24 is exposed (FIG. 5A). Areas bounded with dotted lines in FIG. 5A represent where the underlying electrode 24 is formed under the insulating layer 50.

Subsequently, the resist resin is subjected to patterned exposure in conformity with the shape of the underlying electrode 24. The insulating layer 50 is then immersed in a developing solution capable of dissolving the exposed resist resin. The insulating layer 50 on the underlying electrode 24 is thus removed (FIG. 5B).

In the insulating-layer forming step, the insulating layer 50 is preferably formed on an outer surface of the multilayer body 30 different from the fracture face formed in the breaking step mentioned above.

Outer-Electrode Forming Step

In the outer-electrode forming step, an outer electrode electrically connected with a coil is formed by plating on an outer surface of the multilayer body or an outer surface of the fired multilayer body block.

FIG. 6 is a plan-view schematic illustration of an exemplary method for forming an outer electrode on an underlying electrode.

For example, an outer electrode 40 is formed by electroless plating in a predetermined location on the underlying electrode 24 to thereby form the outer electrode 40 electrically connected with a coil. As illustrated in FIG. 6, the outer electrode 40 is preferably formed in a region surrounded by the insulating layer 50. This helps to prevent abnormal growth of plating.

As seen in a direction perpendicular to the face where the outer electrode 40 and the underlying electrode 24 overlap each other, the outer electrode 40 is preferably located inside relative to the underlying electrode 24. This helps to reduce entry of the plating solution into the base body of the multilayer body 30 in forming the outer electrode 40. As illustrated in FIG. 6, as seen in the direction perpendicular to the face where the outer electrode 40 and the underlying electrode 24 overlap each other, the entire outer electrode 40 may overlap the entire underlying electrode 24. In a case where the entire outer electrode 40 overlaps the entire underlying electrode 24 as well, it can be said that the outer electrode 40 is located inside relative to the underlying electrode 24.

In the outer-electrode forming step, the outer electrode 40 is preferably formed on an outer surface of the multilayer body 30 different from the fracture face formed in the breaking step mentioned above.

With the first embodiment of the coil-component manufacturing method according to the present disclosure, the outer-electrode forming step is performed after the breaking step. In other words, the outer electrode is formed on an outer surface of the multilayer body obtained after the breaking of the fired multilayer body block.

With the first embodiment of the coil-component manufacturing method according to the present disclosure, the insulating-layer forming step mentioned above may be omitted. If no insulating-layer forming step is to be performed, the outer electrode may be simply formed in a predetermined location on the underlying electrode exposed on the multilayer body obtained after the breaking step.

With the first embodiment of the coil-component manufacturing method according to the present disclosure, a coil component with a single coil disposed in a base body may be manufactured, or a coil component with a plurality of coils disposed in a base body may be manufactured.

### Second Embodiment

Reference is now made to a second embodiment of the coil-component manufacturing method according to the present disclosure.

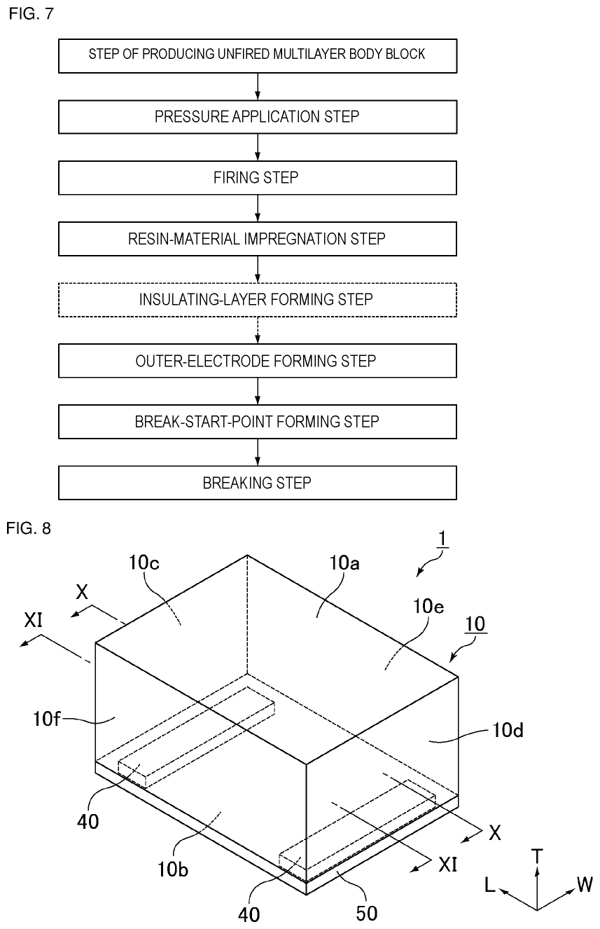

FIG. 7 is a flowchart of a second embodiment of the coil-component manufacturing method according to the present disclosure.

The second embodiment of the coil-component manufacturing method according to the present disclosure differs from the first embodiment of the coil-component manufacturing method according to the present disclosure in the order in which individual steps are performed.

With the second embodiment of the coil-component manufacturing method according to the present disclosure, the step of producing an unfired multilayer body block, the pressure application step, the firing step, the resin-material impregnation step, the insulating-layer forming step, the outer-electrode forming step, the break-start-point forming step, and the breaking step are performed in the stated order.

The individual steps of the second embodiment of the coil-component manufacturing method according to the present disclosure may be the same as those described above with reference to the first embodiment of the coil-component manufacturing method according to the present disclosure.

With the second embodiment of the coil-component manufacturing method according to the present disclosure, the outer-electrode forming step is performed after the resin-material impregnation step and before the break-start-point forming step. In other words, the outer electrode is formed on an outer surface of the fired multilayer body block after the impregnating of the fired multilayer body block with the resin and before the forming of the break start point.

With the second embodiment of the coil-component manufacturing method according to the present disclosure, the outer-electrode forming step is performed before the break-start-point forming step. Accordingly, at the point when the outer electrode is to be formed, no fracture face exists in the multilayer body block. This makes it possible to prevent abnormal growth of plating at the fracture face.

With the second embodiment of the coil-component manufacturing method according to the present disclosure, in the break-start-point forming step and the breaking step, the multilayer body block is preferably broken such that an outer surface of the multilayer body block on which the outer electrode has been formed is not parallel to the fracture face. For example, in the break-start-point forming step and the breaking step, the multilayer body block is preferably broken such that an outer surface of the multilayer body block on which the outer electrode has been formed is perpendicular to the fracture face.

The second embodiment of the coil-component manufacturing method according to the present disclosure may further include, between the step of impregnating the fired multilayer body block with resin and the step of forming the outer electrode, the step of forming an insulating layer in a region on an outer surface of the fired multilayer body block. In this case, the outer electrode is preferably formed in a region surrounded by the insulating layer.

With the second embodiment of the coil-component manufacturing method according to the present disclosure, the multilayer body block is preferably broken such that an outer surface of the multilayer body block different from the outer surface on which the insulating layer has been formed corresponds to the fracture face.

With the second embodiment of the coil-component manufacturing method according to the present disclosure, the insulating-layer forming step may be omitted. If no insulating-layer forming step is to be performed, the outer electrode may be simply formed in a predetermined location on the underlying electrode that is exposed on the multilayer body block after the resin-material impregnation step.

With the second embodiment of the coil-component manufacturing method according to the present disclosure, a coil component with a single coil disposed in a base body may be manufactured, or a coil component with a plurality of coils disposed in a base body may be manufactured.

Coil Component

Reference is now made to a coil component according to the present disclosure.

The coil component according to the present disclosure is preferably manufactured by the coil-component manufacturing method according to the present disclosure.

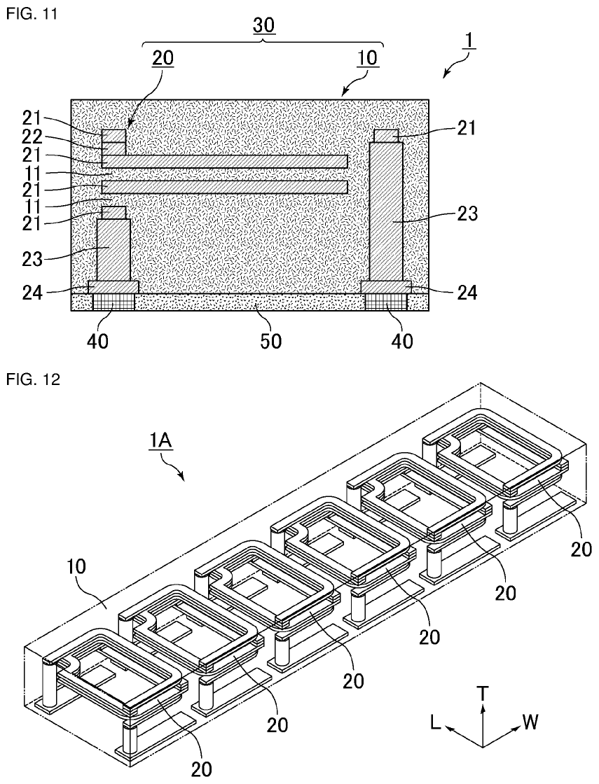

FIG. 8 is a schematic perspective view of an exemplary coil component according to the present disclosure. FIG. 9 is a schematic illustration of the coil component illustrated in FIG. 8, depicting the interior of the coil component in a see-through manner for easy understanding of the structure of the coil. FIG. 10 is a cross-sectional view, taken along a line X-X, of the coil component illustrated in FIG. 8. FIG. 11 is a cross-sectional view, taken along a line XI-XI, of the coil component illustrated in FIG. 8.

As illustrated in FIGS. 8 to 11, a coil component 1 includes the multilayer body 30, and the outer electrode 40. The multilayer body 30 includes the base body 10, and a coil 20 disposed in the base body 10. The outer electrode 40 is electrically connected with the coil 20.

In the example illustrated in FIGS. 8 to 11, the structure of the base body 10 and the structure of the coil 20 correspond to those illustrated in FIGS. 2A to 2L.

The base body 10 includes a plurality of stacked magnetic layers 11. The magnetic layers 11 each include metal magnetic particles. As illustrated in FIGS. 10 and 11, the boundaries between the magnetic layers 11 do not actually appear. Although not illustrated in FIGS. 10 and 11, the base body 10 may include a non-magnetic layer in contact with the coil 20.

The base body 10 is impregnated with resin. Specifically, voids between the metal magnetic particles within the magnetic layers 11 are filled with resin.

In the example illustrated in FIGS. 8 to 11, the base body 10 has a substantially cuboid shape with six faces.

The base body 10 has the following faces: a first major face 10a and a second major face 10b that are opposite to each other in a height direction T; a first end face 10c and a second end face 10d that are opposite to each other in a length direction L; and a first lateral face 10e and a second lateral face 10f that are opposite to each other in a width direction W, which is orthogonal to the height direction T and to the length direction L.

For example, a direction perpendicular to a face of the base body 10 on which the outer electrode 40 is disposed corresponds to the height direction T. In that case, a direction orthogonal to the height direction T corresponds to the length direction L, and a direction orthogonal to the height direction T and to the length direction L corresponds to the width direction W.

In FIGS. 8 and 9, the height direction T, the length direction L, and the width direction W of the coil component 1 and the base body 10 are respectively depicted as directions T, L, and W each represented by an arrow. The height direction T, the length direction L, and the width direction W are orthogonal to each other.

The coil 20 is disposed in the base body 10.

The coil 20 includes a plurality of stacked coil conductor layers 21. In the example illustrated in FIGS. 9 to 11, four coil conductor layers 21 are stacked. The coil 20 may further include via-conductors 22, and extended conductors 23. Each via-conductor 22 connects the coil conductor layers 21 with each other. Each coil conductor layer 21 is electrically connected with the outer electrode 40 via the extended conductor 23.

The outer electrode 40 is disposed on an outer surface of the base body 10. For example, as illustrated in FIGS. 10 and 11, the outer electrode 40 is disposed on the second major face 10b of the base body 10.

The outer electrode 40 is preferably disposed on a surface of the underlying electrode 24.

As seen in a direction perpendicular to the face where the outer electrode 40 and the underlying electrode 24 overlap each other, the outer electrode 40 is preferably located inside relative to the underlying electrode 24. This helps to reduce entry of the plating solution into the base body 10 of the multilayer body 30 in forming the outer electrode 40.

As illustrated in FIGS. 8 to 11, the insulating layer 50 may be disposed in a region on a surface of the base body 10. In that case, the insulating layer 50 is preferably positioned to surround the outer electrode 40. In other words, the outer electrode 40 is preferably disposed in a region surrounded by the insulating layer 50.

### First Embodiment

With a first embodiment of the coil component according to the present disclosure, at least one of the first end face, the second end face, the first lateral face, and the second lateral face has a surface roughness Sa greater than the surface roughness Sa of at least one of the first major face and the second major face.

With the first embodiment of the coil component according to the present disclosure, a face of the coil component with a relatively large surface roughness Sa can be made to have a surface resistance greater than the surface resistance of a face with a relatively small surface roughness Sa. This makes it possible to reduce a decrease in the surface resistance of the surface of the coil component.

The value obtained by subtracting the surface roughness Sa of at least one of the first major face and the second major face from the surface roughness Sa of at least one of the first end face, the second end face, the first lateral face, and the second lateral face may be greater than or equal to 1.0 μm, and less than or equal to 7.0 μm (i.e., from 1.0 μm to 7.0 μm).

The ratio of the surface roughness Sa of at least one of the first major face and the second major face to the surface roughness Sa of at least one of the first end face, the second end face, the first lateral face, and the second lateral face may be greater than or equal to 0.5 and less than or equal to 0.8 (i.e., from 0.5 to 0.8).

At least one of the first end face, the second end face, the first lateral face, and the second lateral face may have a surface roughness Sa of greater than or equal to 3.0 m and less than or equal to 6.0 μm (i.e., 3.0 μm to 6.0 μm) and at least one of the first major face and the second major face may have a surface roughness Sa of greater than or equal to 1.5 μm and less than or equal to 4.5 μm (i.e., from 1.5 μm to 4.5 μm).

The surface roughness Sa means the arithmetic mean surface roughness Sa. The arithmetic mean surface roughness Sa can be measured by use of, for example, a shape-analysis laser microscope (VR-3000 from Keyence Corporation).

With the first embodiment of the coil component according to the present disclosure, the first end face, the second end face, the first lateral face, and the second lateral face may include a face with a surface roughness Sa substantially equal to the surface roughness Sa of the first major face, or may include a face with a surface roughness Sa substantially equal to the surface roughness Sa of the second major face.

The surface of at least one of the first end face, the second end face, the first lateral face, and the second lateral face preferably has a direct-current insulation resistance of greater than or equal to 10⁸ Ω/mm² at a measurement voltage of 100 V, and more preferably, has a direct-current insulation resistance of greater than or equal to 10⁸ Ω/mm² and less than or equal to 10⁹ Ω/mm² (i.e., from 10⁸ Ω/mm² and less than or equal to 10⁹ Ω/mm²) at a measurement voltage of 100 V.

In the above-mentioned case, the at least one of the first end face, the second end face, the first lateral face, and the second lateral face that has a surface with a direct-current insulation resistance of greater than or equal to 10⁸ Ω/mm² at a measurement voltage of 100 V is a face with a greater surface roughness Sa than at least one of the first major face and the second major face.

The direct-current insulation resistance of a surface at a measurement voltage of 100 V can be measured by use of, for example, an electrometer (Electrometer 8252 from ADCMT Corporation). Measuring the direct-current insulation resistance of a surface at a measurement voltage of 100 V makes it possible to evaluate the surface resistance of the surface. For example, if a decrease in the direct-current insulation resistance of a surface at a measurement voltage of 100 V has been successfully reduced, then it can be determined that a decrease in the surface resistance of the surface has been successfully reduced.

### Second Embodiment

With a second embodiment of the coil component according to the present disclosure, the area fractions of resin exposed on the surface of at least one of the first end face, the second end face, the first lateral face, and the second lateral face have a mean value of greater than or equal to 30%, and a standard deviation of less than or equal to 6%.

Resin provides higher insulation than metal magnetic particles. Accordingly, increasing the mean value of the area fractions of resin exposed on a surface of the base body constituting the coil component makes it possible to increase the surface resistance of the surface. Further, decreasing the standard deviation of the area fractions of resin makes it possible to reduce variations in the area fraction of resin within the surface. This makes it possible to reduce a decrease in the surface resistance of the surface of the coil component.

The area fractions of resin exposed on the surface of at least one of the first end face, the second end face, the first lateral face, and the second lateral face may have a mean value of greater than or equal to 30% and less than or equal to 50% (i.e., from 30% to 50%). The area fractions of resin exposed on the surface of at least one of the first end face, the second end face, the first lateral face, and the second lateral face may have a standard deviation of greater than or equal to 1% and less than or equal to 6% (i.e., from 1% to 6%). The area fractions of resin exposed on the surface of at least one of the first end face, the second end face, the first lateral face, and the second lateral face may have a mean value of greater than or equal to 30% and less than or equal to 50% (i.e., from 30% to 50%), and a standard deviation of greater than or equal to 1% and less than or equal to 6% (i.e., from 1% to 6%).

An area fraction of resin can be measured as follows. A reflected electron image of the surface of the base body is captured with a scanning electron microscope (SEM) to thereby obtain a SEM image. After the SEM image is processed by image processing software into a binary image, the area fraction of a portion of the binary image that is covered with a resin material is determined from the binary image. For example, for three samples, their SEM photographs are captured at a 1000-fold magnification, and each photograph is divided into 25 parts to thereby obtain a total of 75 images. For the 75 images, the corresponding area fractions of resin are calculated. In this way, the mean and the standard deviation of the area fractions of resin can be measured. The images obtained by dividing each photograph into 25 parts may be, for example, images each capturing an area that measures 16 μm vertically and 22 μm horizontally.

At least one of the first end face, the second end face, the first lateral face, and the second lateral face preferably has a surface with a direct-current insulation resistance of greater than or equal to 10⁸ Ω/mm² at a measurement voltage of 100 V, and more preferably, has a surface with a direct-current insulation resistance of greater than or equal to 10⁸ Ω/mm² and less than or equal to 10⁹ Ω/mm² (i.e., from 10⁸ Ω/mm² and less than or equal to 10⁸ Ω/mm²) at a measurement voltage of 100 V.

In the above-mentioned case, the at least one of the first end face, the second end face, the first lateral face, and the second lateral face that has a surface with a direct-current insulation resistance of greater than or equal to 10⁸ Ω/mm² at a measurement voltage of 100 V is a face where the area fractions of resin exposed on its surface have a mean value of greater than or equal to 30% and a standard deviation of less than or equal to 6%.

With the second embodiment of the coil component according to the present disclosure, at least one of the first end face, the second end face, the first lateral face, and the second lateral face may have a surface roughness Sa greater than the surface roughness Sa of at least one of the first major face and the second major face.

In that case, the value obtained by subtracting the surface roughness Sa of at least one of the first major face and the second major face from the surface roughness Sa of at least one of the first end face, the second end face, the first lateral face, and the second lateral face may be greater than or equal to 1.0 μm, and less than or equal to 7.0 μm (i.e., from 1.0 μm to 7.0 μm).

The ratio of the surface roughness Sa of at least one of the first major face and the second major face to the surface roughness Sa of at least one of the first end face, the second end face, the first lateral face, and the second lateral face may be greater than or equal to 0.5 and less than or equal to 0.8 (i.e., from 0.5 to 0.8).

With the second embodiment of the coil component according to the present disclosure, if at least one of the first end face, the second end face, the first lateral face, and the second lateral face has a surface roughness Sa greater than the surface roughness Sa of at least one of the first major face and the second major face, the at least one of the first end face, the second end face, the first lateral face, and the second lateral face that has a greater surface roughness Sa than at least one of the first major face and the second major face is a face where the area fractions of resin exposed on its face have a mean value of greater than or equal to 30% and a standard deviation of less than or equal to 6%.

At least one of the first end face, the second end face, the first lateral face, and the second lateral face may have a surface roughness Sa of greater than or equal to 3.0 m and less than or equal to 6.0 μm (i.e., from 3.0 μm to 6.0 μm), and at least one of the first major face and the second major face may have a surface roughness Sa of greater than or equal to 1.5 μm and less than or equal to 4.5 μm (i.e., from 1.5 μm to 4.5 μm).

The coil component according to the present disclosure may include a single coil disposed in the base body as illustrated in FIG. 9, or may include a plurality of coils disposed in the base body as illustrated in FIGS. 12 to 14.

FIG. 12 is a perspective-view schematic illustration of a first modification of the internal structure of the coil component according to the present disclosure.

A coil component 1A illustrated in FIG. 12 includes six coils 20 arranged linearly in the base body 10. The six coils 20 are all arranged in the same orientation.

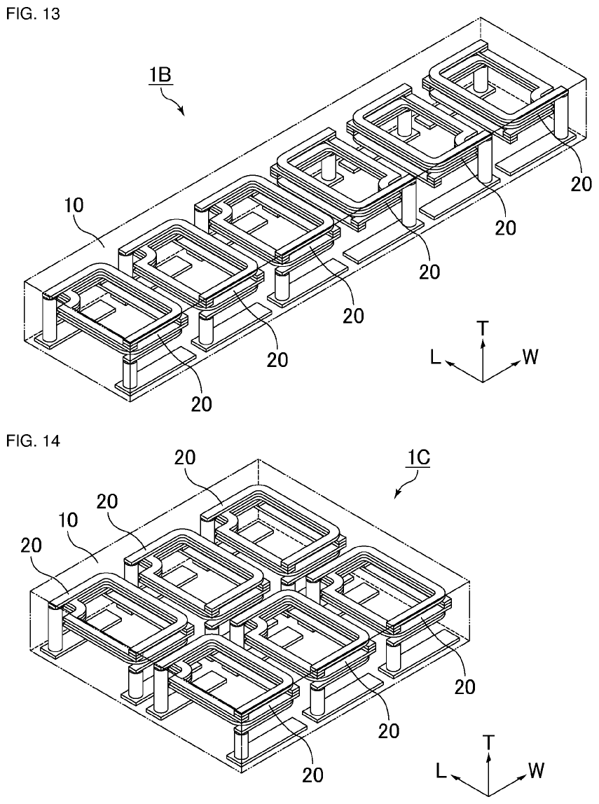

FIG. 13 is a perspective-view schematic illustration of a second modification of the internal structure of the coil component according to the present disclosure.

A coil component 1B illustrated in FIG. 13 includes six coils 20 arranged linearly in the base body 10. The six coils 20 include two sets of three coils that are arranged symmetrically to each other in their pattern shapes. Such a symmetrical arrangement of the pattern shapes of the coils 20 helps to reduce variations in inductance between the coils 20.

FIG. 14 is a perspective-view schematic illustration of a third modification of the internal structure of the coil component according to the present disclosure.

A coil component 1C illustrated in FIG. 14 includes six coils 20 arranged in a planar manner in the base body 10. The six coils 20 are all arranged in the same orientation. In the example illustrated in FIG. 14, two coils 20 are disposed in the length direction L, and three coils 20 are disposed in the width direction W. Alternatively, for example, three coils 20 may be disposed in the length direction L, and two coils 20 may be disposed in the width direction W.

The present disclosure herein discloses the following features presented below.

<1> A coil-component manufacturing method including the steps of producing an unfired multilayer body block including a stack of an unsintered magnetic layer and an unsintered coil conductor layer, the unsintered magnetic layer including metal magnetic particles; applying pressure to the unfired multilayer body block; and by firing the unfired multilayer body block, producing a fired multilayer body block including a stack of a magnetic layer and a coil conductor layer. The magnetic layer includes the metal magnetic particles; impregnating the fired multilayer body block with resin. The coil-component manufacturing method also includes by scribing a surface of the fired multilayer body block impregnated with the resin, forming a break start point in the surface of the fired multilayer body block; and by breaking the fired multilayer body block impregnated with the resin into individual chip units, producing a multilayer body. The multilayer body includes a base body and at least one coil disposed in the base body. The breaking is performed by application of a pressing force to the break start point from a surface of the fired multilayer body block opposite from the surface in which the break start point has been formed. The base body includes a stack of a plurality of the magnetic layers, and the at least one coil includes a stack of a plurality of the coil conductor layers. The coil-component manufacturing method further includes by plating, forming an outer electrode on an outer surface of the multilayer body or on an outer surface of the fired multilayer body block. The outer electrode is electrically connected with the at least one coil.

<2> The coil-component manufacturing method according to Item <1>, in which the outer electrode is formed on the outer surface of the multilayer body obtained after the breaking of the fired multilayer body block.

<3> The coil-component manufacturing method according to Item <2>, further including, between the step of breaking the fired multilayer body block and the step of forming the outer electrode, the step of forming an insulating layer in a region on the outer surface of the multilayer body, in which the outer electrode is formed in a region surrounded by the insulating layer.

<4> The coil-component manufacturing method according to Item <1>, in which the outer electrode is formed on the outer surface of the fired multilayer body block after the impregnating of the fired multilayer body block with the resin and before the forming of the break start point.

<5> The coil-component manufacturing method according to Item <4>, further including, between the step of impregnating the fired multilayer body block with the resin and the step of forming the outer electrode, the step of forming an insulating layer in a region on the outer surface of the fired multilayer body block, in which the outer electrode is formed in a region surrounded by the insulating layer.

<6> The coil-component manufacturing method according to any one of Items <1> to <5>, in which the at least one coil disposed in the base body includes a single coil.

<7> The coil-component manufacturing method according to any one of Items <1> to <5>, in which the at least one coil disposed in the base body includes a plurality of coils.

<8> A coil component includes a multilayer body including a base body, and at least one coil disposed in the base body, the base body including a stack of a plurality of magnetic layers, the at least one coil including a stack of a plurality of coil conductor layers; and an outer electrode that is disposed on an outer surface of the base body, and that is electrically connected with the at least one coil. The plurality of magnetic layers each include metal magnetic particles. The base body is impregnated with resin. The base body has a first major face and a second major face that are opposite to each other in a height direction, a first end face and a second end face that are opposite to each other in a length direction orthogonal to the height direction, and a first lateral face and a second lateral face that are opposite to each other in a width direction. The width direction being orthogonal to the height direction and to the length direction. At least one of the first end face, the second end face, the first lateral face, and the second lateral face has a surface roughness Sa greater than a surface roughness Sa of at least one of the first major face and the second major face.

<9> The coil component according to Item <8>, in which at least one of the first end face, the second end face, the first lateral face, and the second lateral face has a surface roughness Sa of greater than or equal to 3.0 μm and less than or equal to 6.0 μm (i.e., from 3.0 μm to 6.0 μm), and in which at least one of the first major face and the second major face has a surface roughness Sa of greater than or equal to 1.5 μm and less than or equal to 4.5 μm (i.e., from 1.5 μm to 4.5 μm).

<10> The coil component according to Item <8> or <9>, in which the at least one coil disposed in the base body includes a single coil.

<11> The coil component according to Item <8> or <9>, in which the at least one coil disposed in the base body includes a plurality of coils.

<12> The coil component according to any one of Items <8> to <11>, in which at least one of the first end face, the second end face, the first lateral face, and the second lateral face has a surface with a direct-current insulation resistance of greater than or equal to 10⁸ Ω/mm² at a measurement voltage of 100 V.

<13> The coil component according to Item <12>, in which the direct-current insulation resistance is greater than or equal to 10⁸ Ω/mm² and less than or equal to 10⁹ Ω/mm² (i.e., from 10⁸ Ω/mm² to 10⁹ Ω/mm²).

<14> A coil component including a multilayer body including a base body, and at least one coil disposed in the base body, the base body including a stack of a plurality of magnetic layers, the at least one coil including a stack of a plurality of coil conductor layers; and an outer electrode that is disposed on an outer surface of the base body, and that is electrically connected with the at least one coil. The plurality of magnetic layers each include metal magnetic particles. The base body is impregnated with resin. The base body has a first major face and a second major face that are opposite to each other in a height direction, a first end face and a second end face that are opposite to each other in a length direction orthogonal to the height direction, and a first lateral face and a second lateral face that are opposite to each other in a width direction. The width direction is orthogonal to the height direction and to the length direction. Area fractions of the resin exposed on a surface of at least one of the first end face, the second end face, the first lateral face, and the second lateral face have a mean value of greater than or equal to 30%, and a standard deviation of less than or equal to 6%.

<15> The coil component according to Item <14>, in which the area fractions of the resin have a mean value of greater than or equal to 30% and less than or equal to 50% (i.e., from 30% to 50%), and a standard deviation of greater than or equal to 1% and less than or equal to 6% (i.e., from 1% to 6%).

<16> The coil component according to Item <14> or <15>, in which the at least one coil disposed in the base body includes a single coil.

<17> The coil component according to Item <14> or <15>, in which the at least one coil disposed in the base body includes a plurality of coils.

<18> The coil component according to any one of Items <14> to <17>, in which at least one of the first end face, the second end face, the first lateral face, and the second lateral face has a surface with a direct-current insulation resistance of greater than or equal to 10⁸ Ω/mm² at a measurement voltage of 100 V.

<19> The coil component according to Item <18>, in which the direct-current insulation resistance is greater than or equal to 10⁸ Ω/mm² and less than or equal to 10⁹ Ω/mm² (i.e., from 10⁸ Ω/mm² to 10⁹ Ω/mm²).

<20>

The coil component according to any one of Items <14> to <19>, in which at least one of the first end face, the second end face, the first lateral face, and the second lateral face has a surface roughness Sa greater than a surface roughness Sa of at least one of the first major face and the second major face.

### EXAMPLES

Reference is now made to Examples that disclose the coil-component manufacturing method and the coil component according to the present disclosure in a more specific manner. The present disclosure, however, is not limited to such Examples.

A coil component according to Example was produced by the method described above with reference to the second embodiment of the coil-component manufacturing method according to the present disclosure. A coil component according to Comparative Example was produced by the method described above with reference to the second embodiment of the coil-component manufacturing method according to the present disclosure, except that the break-start-point forming step and the breaking step were replaced by an alternative step of cutting the multilayer body block with a dicer. The coil component according to Example was produced such that the fracture face obtained through the break-start-point forming step and the breaking step is a lateral face of the coil component. The coil component according to Comparative Example was produced such that the cut face obtained by cutting with the dicer is a lateral face of the coil component. In the following description, a lateral face of the coil component according to Example refers to a lateral face of the coil component corresponding to the fracture face obtained through the break-start-point forming step and the breaking step, and a lateral face of the coil component according to Comparative Example refers to a lateral face of the coil component corresponding to the cut face obtained by cutting with the dicer.

For each of Example and Comparative Example, the arithmetic mean surface roughness Sa of the top face (first major face) of the coil component, and the arithmetic mean surface roughness Sa of the lateral face of the coil component were measured with a shape-analysis laser microscope (VR-3000 from Keyence Corporation). The results are presented in Table 1.

Additionally, a reflected electron image of the lateral face of the coil component was captured with a SEM. The resulting SEM image was processed by image processing software into a binary image. From the binary image, the area fraction of a portion of the image covered with a resin material was determined. Specifically, for three samples according to Example and three samples according to Comparative Example, their SEM photographs were captured at a 1000-fold magnification, and each photograph was divided into 25 parts to thereby obtain a total of 75 images. For each of the 75 images, the corresponding area fractions of resin were calculated. In this way, the mean and standard deviation (SD) of the area fractions of resin were measured. The images obtained by dividing each photograph into 25 parts were images each capturing an area that measures 16 μm vertically and 22 μm horizontally. The results are presented in Table 1.

TABLE 1

| | Surface roughness Sa (μm) | | Area fractions of resin (%) | |
|---|---|---|---|---|
| | Top face | Lateral face | Mean | SD |
| Example | 3.2 | 4.5 | 43 | 5 |
| Comparative | 3.2 | 1.7 | 22 | 17 |
| Example | | | | |

Subsequently, for each of Example and Comparative Example, the direct-current insulation resistance of the lateral face of the coil component was measured with an electrometer (Electrometer 8252 from ADCMT Corporation).

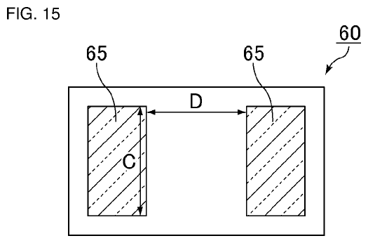

FIG. 15 is a plan-view schematic illustration of a method for measuring direct-current insulation resistance.

As illustrated in FIG. 15, resin Ag electrodes 65 were formed on a surface (which in this case is the lateral face of the coil component) of a sample 60. The +/−terminal of the electrometer was then placed on each of the resin Ag electrodes 65, and the resistance was measured with increasing applied voltage. The direct-current insulation resistance of the surface was calculated based on the equation below, where the electrode width is defined as the length represented by a double-headed arrow C in FIG. 15, and the electrode-to-electrode distance is defined as the length represented by a double-headed arrow D in FIG. 15.

Direct-current insulation resistance [Ω/mm²] of surface=resistance [Ω]/(electrode width [mm]×electrode-to-electrode distance [mm])

For three coil components according to Example and three coil components according to Comparative Example, the direct-current insulation resistance was measured at a measurement voltage (DC) of 1, 10, 20, 40, 50, or 100 V. The results revealed that, for each coil component according to Comparative Example, even under the measurement voltage of 1V, the direct-current insulation resistance decreased nearly to 10² Ω/mm², which is the lower limit of measurement, and measurement was impossible with voltages higher than this voltage. By contrast, for each coil component according to Example, the direct-current insulation resistance was greater than or equal to 10⁸ Ω/mm² at all measurement voltages. This confirmed that the coil component according to Example exhibits a high surface resistance.

What is claimed is:

1. A coil-component manufacturing method comprising:
producing an unfired multilayer body block including a stack of an unsintered magnetic layer and an unsintered coil conductor layer, the unsintered magnetic layer including metal magnetic particles;
applying pressure to the unfired multilayer body block;
by firing the unfired multilayer body block, producing a fired multilayer body block including a stack of a magnetic layer and a coil conductor layer, the magnetic layer including the metal magnetic particles;
impregnating the fired multilayer body block with resin;
by scribing a surface of the fired multilayer body block impregnated with the resin, forming a break start point in the surface of the fired multilayer body block;
by breaking the fired multilayer body block impregnated with the resin into individual chip units, producing a multilayer body, the multilayer body including a base body and at least one coil disposed in the base body, the breaking being performed by application of a pressing force to the break start point from a surface of the fired multilayer body block opposite from the surface in which the break start point has been formed, the base body including a stack of a plurality of the magnetic layers, and the at least one coil including a stack of a plurality of the coil conductor layers; and
by plating, forming an outer electrode on an outer surface of the multilayer body or on an outer surface of the fired multilayer body block, the outer electrode being electrically connected with the at least one coil.

2. The coil-component manufacturing method according to claim 1, wherein
the outer electrode is formed on the outer surface of the multilayer body obtained after the breaking of the fired multilayer body block.

3. The coil-component manufacturing method according to claim 2, further comprising:
between the breaking of the fired multilayer body block and the forming of the outer electrode, forming an insulating layer in a region on the outer surface of the multilayer body,
wherein the outer electrode is formed in a region surrounded by the insulating layer.

4. The coil-component manufacturing method according to claim 1, wherein
the outer electrode is formed on the outer surface of the fired multilayer body block after the impregnating of the fired multilayer body block with the resin and before the forming of the break start point.

5. The coil-component manufacturing method according to claim 4, further comprising:
between the impregnating of the fired multilayer body block with the resin and the forming of the outer electrode, forming an insulating layer in a region on the outer surface of the fired multilayer body block,
wherein the outer electrode is formed in a region surrounded by the insulating layer.

6. The coil-component manufacturing method according to claim 1, wherein
the at least one coil disposed in the base body comprises a single coil.

7. The coil-component manufacturing method according to claim 1, wherein
the at least one coil disposed in the base body comprises a plurality of coils.

8. A coil component comprising:
a multilayer body including a base body, and at least one coil disposed in the base body, the base body including a stack of a plurality of magnetic layers, the at least one coil including a stack of a plurality of coil conductor layers; and
an outer electrode that is disposed on an outer surface of the base body, and that is electrically connected with the at least one coil,
wherein
the plurality of magnetic layers each include metal magnetic particles,
the base body is impregnated with resin,
the base body has
a first major face and a second major face that are opposite to each other in a height direction,
a first end face and a second end face that are opposite to each other in a length direction orthogonal to the height direction, and
a first lateral face and a second lateral face that are opposite to each other in a width direction, the width direction being orthogonal to the height direction and to the length direction, and
at least one of the first end face, the second end face, the first lateral face, and the second lateral face has a surface roughness Sa greater than a surface roughness Sa of at least one of the first major face and the second major face.

9. The coil component according to claim 8, wherein
at least one of the first end face, the second end face, the first lateral face, and the second lateral face has a surface roughness Sa of from 3.0 μm to 6.0 μm, and
wherein at least one of the first major face and the second major face has a surface roughness Sa of from 1.5 μm to 4.5 μm.

10. The coil component according to claim 8, wherein
the at least one coil disposed in the base body comprises a single coil.

11. The coil component according to claim 8, wherein
the at least one coil disposed in the base body comprises a plurality of coils.

12. The coil component according to claim 8, wherein
at least one of the first end face, the second end face, the first lateral face, and the second lateral face has a surface with a direct-current insulation resistance of greater than or equal to 10⁸ Ω/mm² at a measurement voltage of 100 V.

13. The coil component according to claim 12, wherein
the direct-current insulation resistance is from 10⁸ Ω/mm² to 10⁹ Ω/mm².

14. A coil component comprising:
a multilayer body including a base body, and at least one coil disposed in the base body, the base body including a stack of a plurality of magnetic layers, the at least one coil including a stack of a plurality of coil conductor layers; and
an outer electrode that is disposed on an outer surface of the base body, and that is electrically connected with the at least one coil,
wherein
the plurality of magnetic layers each include metal magnetic particles,
the base body is impregnated with resin,
the base body has
a first major face and a second major face that are opposite to each other in a height direction,
a first end face and a second end face that are opposite to each other in a length direction orthogonal to the height direction, and
a first lateral face and a second lateral face that are opposite to each other in a width direction, the width direction being orthogonal to the height direction and to the length direction, and
area fractions of the resin exposed on a surface of at least one of the first end face, the second end face, the first lateral face, and the second lateral face have a mean value of greater than or equal to 30%, and a standard deviation of less than or equal to 6%.

15. The coil component according to claim 14, wherein
the area fractions of the resin have a mean value of from 30% to 50%, and a standard deviation of from 1% to 6%.

16. The coil component according to claim 14, wherein
the at least one coil disposed in the base body comprises a single coil.

17. The coil component according to claim 14, wherein
the at least one coil disposed in the base body comprises a plurality of coils.

18. The coil component according to claim 14, wherein
at least one of the first end face, the second end face, the first lateral face, and the second lateral face has a surface with a direct-current insulation resistance of greater than or equal to 10⁸ Ω/mm² at a measurement voltage of 100 V.

19. The coil component according to claim 18, wherein
the direct-current insulation resistance is from 10⁸ Ω/mm² to 10⁹ Ω/mm².

20. The coil component according to claim 14, wherein
at least one of the first end face, the second end face, the first lateral face, and the second lateral face has a surface roughness Sa greater than a surface roughness Sa of at least one of the first major face and the second major face.
